(19) United States
(12) Patent Application Publication
(10) Pub. No.: US 2026/0298023 A1
(43) Pub. Date: Oct. 1, 2026

(54) SYSTEMS AND METHODS FOR LIFE SAFETY IN BUILT ENVIRONMENT THRESHOLDS

(71) Applicant: Jack Schonberger, Tom's River, NJ (US)

(72) Inventor: Jack Schonberger, Tom's River, NJ (US)

(21) Appl. No.: 19/542,899

(22) Filed: Feb. 18, 2026

Related U.S. Application Data
(60) Provisional application No. 63/734,664, filed on Dec. 16, 2024.

(51) Int. Cl. E06B 9/52

(52) U.S. Cl. CPC E06B 9/522; E06B 2009/524; E06B 2009/527

(57) ABSTRACT

A system may include a square channel forming a first frame assembly, the square channel being configured to provide structural support. A system may include a U channel configured to engage with the square channel, the U channel being adjustable to accommodate varying window dimensions. A system may include a corner unit configured to connect with the square channel, forming a rigid enclosure. A system may include a screen disposed over the first frame assembly, the screen being constructed from a durable material resistant to tearing. A system may include fastening means for securing the U channel to the square channel, thereby integrating the screen into the window frame, wherein the child safety screen system is configured to prevent accidental falls from the window.

### BACKGROUND OF THE INVENTION

This application relates to systems and methods for securing human safety around apertures in the built environment, such as fixed closures for window and doorways.

### TECHNICAL FIELD

The present disclosure generally relates to safety systems for preventing accidental falls and more particularly to protective screen systems designed to secure window and doorway openings, ensuring child safety and preventing unintended egress.

### DESCRIPTION OF THE RELATED ART

Existing solutions to the problem being solved often include traditional window screens that are weak, easily dislodged, and/or prone to tearing, which fail to provide adequate safety for preventing accidental falls from windows. These solutions typically require professional installation and do not offer the flexibility or ease of use needed for effective implementation of child safety measures.

### SUMMARY OF THE INVENTION

In general, in a first aspect, the techniques described herein relate to a child safety screen system configured for installation within a window frame, including: a square channel forming a first frame assembly, the square channel being configured to provide structural support; a U channel configured to engage with the square channel, the U channel being adjustable to accommodate varying window dimensions; a corner unit configured to connect with the square channel, forming a rigid enclosure; a screen disposed over the first frame assembly, the screen being constructed from a durable material resistant to tearing; and fastening means for securing the U channel to the square channel, thereby integrating the screen into the window frame, wherein the child safety screen system is configured to prevent accidental falls from the window.

In some aspects, the techniques described herein relate to a child safety screen system, further including a plurality of corner units, each configured to enhance the structural integrity of the first frame assembly.

In some aspects, the techniques described herein relate to a child safety screen system, wherein screen is constructed from a plastic or a metal alloy.

In some aspects, the techniques described herein relate to a child safety screen system, further including a protective coating on the screen to enhance durability and weather resistance.

In some aspects, the techniques described herein relate to a child safety screen system, wherein the U channel is configured to slide over the square channel, allowing for adjustable positioning of the screen.

In some aspects, the techniques described herein relate to a child safety screen system, wherein the fastening means includes screws configured to penetrate the U channel and square channel, securing the screen in place.

In some aspects, the techniques described herein relate to a child safety screen system, wherein the system is configured for installation from the interior of a building, eliminating the need for external access.

In some aspects, the techniques described herein relate to a child safety screen system, further including a locking mechanism configured to prevent unauthorized removal of the screen from the window frame.

In some aspects, the techniques described herein relate to a child safety screen system, wherein the method of manufacturing the frame assembly involves an extrusion process, the process being economical for both metal and plastic materials, including: extruding the square and U channels from a selected material, wherein the extrusion process is optimized to minimize material waste and reduce production costs; cutting the extruded components to predetermined lengths suitable for assembly into the frame structure; applying a surface treatment to the extruded components to enhance durability and resistance to environmental factors.

In some aspects, the techniques described herein relate to a child safety screen system, wherein the method of manufacturing the screen material includes: weaving metal wires into a mesh configuration for the metal screen, ensuring uniformity and strength across the screen surface; or molding plastic into a mesh configuration for the plastic screen, utilizing a process that ensures flexibility and resilience while maintaining structural integrity.

In some aspects, the techniques described herein relate to a method 10, wherein the metal screen is attached to the frame by a crimping process, or the plastic screen is attached by a thermal bonding process, each method selected to optimize durability and cost-effectiveness for the respective material.

In some aspects, the techniques described herein relate to a child safety screen system, wherein the frame assembly and screen material are constructed from a variety of materials, including: Metals: aluminum, steel, stainless steel, titanium, copper, brass, bronze, or nickel alloys; and Plastics: polyvinyl chloride (PVC), polyethylene (PE), polypropylene (PP), polycarbonate (PC), acrylonitrile butadiene styrene (ABS), polystyrene (PS), or nylon.

In some aspects, the techniques described herein relate to a modular safety screen system for use in various protective applications, including: a plurality of frame assemblies, each frame assembly including a square channel and a U channel, the channels being configured to interlock and form a continuous barrier; a plurality of corner units configured to connect adjacent frame assemblies, thereby forming a modular enclosure; one or more screens, each screen being inserted between each frame assembly and constructed from a high-strength material; and fastening means for securing each screen to its respective frame assembly, wherein the modular safety screen system is adaptable to serve as a window-mounted child safety screen, a deck barrier, or an animal enclosure.

In some aspects, the techniques described herein relate to a modular safety screen system, wherein each screen is constructed from a mesh material with a tensile strength sufficient to withstand impact forces.

In some aspects, the techniques described herein relate to a modular safety screen system, further including a plurality of extension units configured to increase the height of the modular enclosure for use as a deck barrier.

In some aspects, the techniques described herein relate to a modular safety screen system, wherein the fastening means includes a series of clips configured to engage with the U channel and secure the screen.

In some aspects, the techniques described herein relate to a modular safety screen system, further including a hinge mechanism configured to allow selective opening of a portion of the modular enclosure.

In some aspects, the techniques described herein relate to a modular safety screen system, wherein the system is configured for tool-free assembly and disassembly, facilitating ease of installation and relocation.

In some aspects, the techniques described herein relate to a modular safety screen system, further including a weather-resistant sealant applied to the frame assemblies to prevent moisture ingress.

In some aspects, the techniques described herein relate to a modular safety screen system, wherein the system is configured to be expandable by adding additional frame assemblies and corner units, allowing for customizable enclosure dimensions and/or shapes.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF THE FIGURES

At least one specification heading is required. Please delete this heading section if it is not applicable to your application. For more information regarding the headings of the specification, please see MPEP 608.01(a).

FIG. 1 illustrates a child safety screen system installed within a window frame, showcasing its protective function to prevent accidental falls.

FIG. 2 depicts an exploded view of a frame assembly system, highlighting the interlocking C channels and corner brackets for secure construction.

FIG. 3 shows an assembled frame structure, emphasizing the integration of square and C channels to form a rigid enclosure.

FIG. 4 illustrates a corner bracket subsystem, detailing the components that connect and secure the frame assembly.

FIG. 5A-5C presents various views of a square channel, demonstrating its role in providing structural support within the frame assembly.

FIG. 6A-6C displays a C channel in multiple views, highlighting its design for engaging with a square channel to form a secure connection.

FIG. 7 shows a fully assembled life safety system, featuring a C channel frame around a durable screen for enhanced protection.

FIG. 8 illustrates an alternative life safety system configuration, where the C channel frame is the only visible component, providing a seamless appearance.

FIG. 9A-9B depicts a corner bracket assembly, showcasing its components designed for secure connection and structural integrity within the frame.

FIG. 10A-10D illustrates a detailed corner bracket subsystem, emphasizing the ergonomic and aesthetic features for enhanced assembly and stability.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known structures, functions, methods, procedures, components, and/or circuitry have been described at a relatively high level, without detail, to avoid unnecessarily obscuring aspects of the present teachings.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application.

When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

As noted, existing platforms are ineffective or inefficient as they depend on installation externally to the built environment, and/or are not designed for securing human lives from falling out of the built environment, and often are unable to integrate seamlessly with interior design requirements. To address the challenges associated with traditional methods of adding life safety to a building threshold, techniques are described that implement systems and methods for life safety in built environment thresholds.

In example aspects, the techniques described herein relate to a child safety screen system configured for installation within a window frame, including: a square channel forming a first frame assembly, the square channel being configured to provide structural support; a U channel configured to engage with the square channel, the U channel being adjustable to accommodate varying window dimensions; a corner unit configured to connect with the square channel, forming a rigid enclosure; a screen disposed over the first frame assembly, the screen being constructed from a durable material resistant to tearing; and fastening means for securing the U channel to the square channel, thereby integrating the screen into the window frame, wherein the child safety screen system is configured to prevent accidental falls from the window.

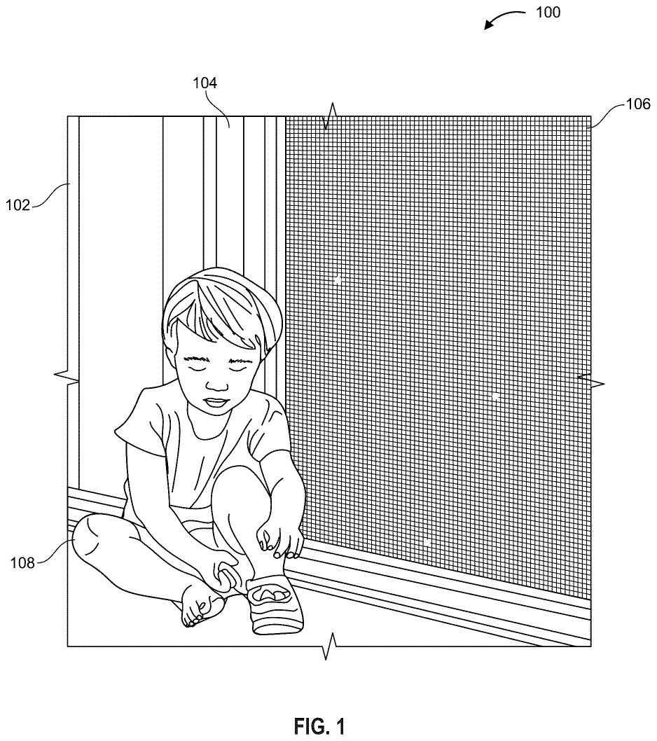

Referring to the FIG. 1, which illustrates a child and pet safety system, the system may be configured for installation within a window frame to prevent accidental falls. In certain aspects, the system may include a square channel 102 forming a first frame assembly. This square channel 102 may be configured to provide structural support and may be constructed from materials such as aluminum, steel, or high-strength plastic, each offering varying degrees of rigidity and durability. The square channel 102 may be designed to interlock with other components, forming a secure enclosure around the window or door opening.

In some aspects, the system may further include a U channel 104 configured to engage with the square channel 102. The U channel 104 may be adjustable to accommodate varying window dimensions, allowing for a customizable fit. This component may be fabricated from similar materials as the square channel 102, ensuring compatibility and structural integrity. The U channel 104 may slide over the square channel 102, providing an adjustable positioning mechanism for the screen.

In various aspects, a corner unit may be configured to connect with the square channel 102, forming a rigid enclosure. The corner unit may enhance the structural integrity of the first frame assembly, ensuring that the system remains stable under applied forces. This component may be constructed from durable materials such as reinforced plastic or metal alloys, providing additional support at the junctions of the frame assembly.

In several aspects, the system may include a screen 106 disposed over the first frame assembly. The screen 106 may be constructed from a durable material resistant to tearing, such as metal mesh or high-strength plastic. This screen 106 may serve as a barrier to prevent accidental falls from the window, while still allowing for airflow and visibility. The screen 106 may be treated with a protective coating to enhance its durability and weather resistance, ensuring long-term performance in various environmental conditions.

In other aspects, the system may include fastening means for securing the U channel 104 to the square channel 102, thereby integrating the screen 106 into the window frame. These fastening means may comprise screws or other mechanical fasteners configured to penetrate the U channel 104 and square channel 102, securing the screen 106 in place. The fastening means may be designed to maintain the integrity of the system under applied pressure, preventing unauthorized removal or accidental dislodgement.

In many aspects, the system may be configured for installation from the interior of a building, eliminating the need for external access. This feature may facilitate ease of installation and maintenance, allowing users to install the system without professional assistance. The system may also include a locking mechanism configured to prevent unauthorized removal of the screen 106 from the window frame, enhancing security and safety.

In certain aspects, the method of manufacturing the frame assembly may involve an extrusion process, which may be economical for both metal and plastic materials. This process may include extruding the square and U channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In some aspects, the method of manufacturing the screen material may comprise weaving metal wires into a mesh configuration for the metal screen 106, ensuring uniformity and strength across the screen surface. Alternatively, the screen 106 may be molded from plastic into a mesh configuration, utilizing a process that ensures flexibility and resilience while maintaining structural integrity. The metal screen 106 may be attached to the frame by a crimping process, or the plastic screen 106 may be attached by a thermal bonding process, each method selected to optimize durability and cost-effectiveness for the respective material.

In various aspects, the frame assembly and screen material may be constructed from a variety of materials, including metals such as aluminum, steel, stainless steel, titanium, copper, brass, bronze, or nickel alloys, and plastics such as polyvinyl chloride (PVC), polyethylene (PE), polypropylene (PP), polycarbonate (PC), acrylonitrile butadiene styrene (ABS), polystyrene (PS), or nylon. These materials may be selected based on their properties, such as rigidity, transparency, and resistance to environmental factors, to ensure the system's performance and longevity.

In several aspects, the system may be adaptable for use in various protective applications, including as a window-mounted child safety screen, a deck barrier, or an animal enclosure. The modular design may allow for the addition of extension units to increase the height of the enclosure, making it suitable for different environments and use cases. The system may also include a hinge mechanism configured to allow selective opening of a portion of the enclosure, providing flexibility and convenience for users.

In other aspects, the system may be configured for tool-free assembly and disassembly, facilitating ease of installation and relocation. This feature may be particularly beneficial for users who require a temporary or portable safety solution. The system may also include a weather-resistant sealant applied to the frame assemblies to prevent moisture ingress, ensuring the system's durability in outdoor environments.

In many aspects, the system may be expandable by adding additional frame assemblies and corner units, allowing for customizable enclosure dimensions and/or shapes. This flexibility may enable users to tailor the system to their specific needs, whether for residential, commercial, or industrial applications. The system's adaptability and ease of use may provide a competitive advantage over existing safety solutions, addressing major real-world problems related to child and pet safety.

In certain aspects, the materials chosen for the construction of the system may be optimized for cost-effective procurement and shipping across wide geographical areas, such as the United States. Utilizing lightweight materials like aluminum alloys or high-strength plastics can significantly reduce shipping costs due to lower weight. Additionally, the components may be designed to nest or stack efficiently, minimizing packaging volume and further reducing transportation expenses.

For consumers seeking premium options, the system may be offered with luxury materials such as anodized titanium frames or screens made from custom-designed architectural bronze mesh. These materials not only enhance aesthetic appeal but also provide superior durability and corrosion resistance, catering to high-end markets or architectural applications where design is a priority.

In conclusion, the child and pet safety system as depicted in the figure may offer a versatile and effective solution for preventing accidental falls and ensuring safety in various environments. The system's modular design, durable materials, and user-friendly features may make it an attractive option for a wide range of applications, providing peace of mind for users and enhancing safety in homes and other settings.

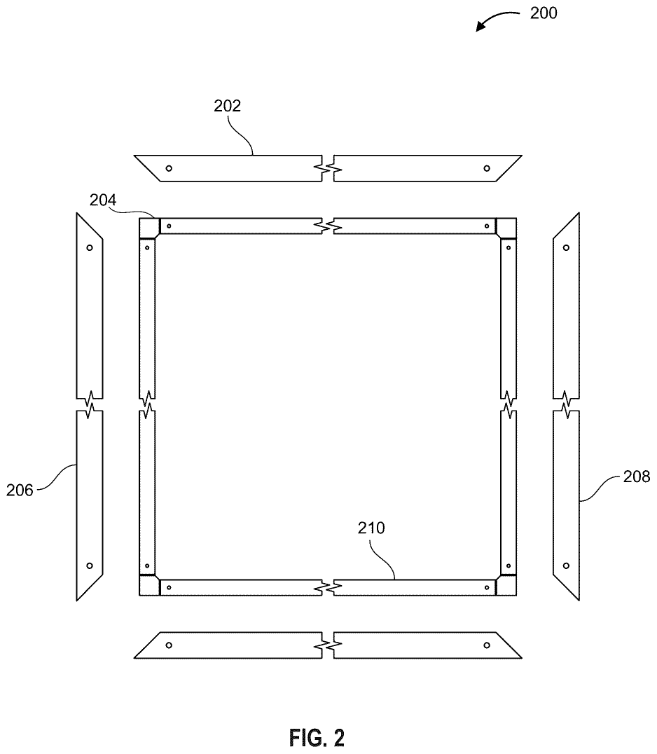

Referring to FIG. 2, the system for aperture and opening security is depicted in an exploded view, illustrating the assembly of various components. In certain aspects, the system may include a first C channel extrusion material 202, which forms part of the structural framework. This C channel 202 may be configured to provide structural support and may be fabricated from materials such as aluminum or steel, offering rigidity and durability. The C channel 202 may be designed to interlock with other components, forming a secure enclosure around the aperture.

In some aspects, the system may further include a corner bracket piece 204. The corner bracket 204 may be configured to connect with the first C channel 202, forming a rigid enclosure. This component may enhance the structural integrity of the assembly, ensuring stability under applied forces. One or more of these corner brackets 204 may be constructed from durable materials such as reinforced plastic or metal alloys, providing additional support at the junctions of the frame assembly.

In various aspects, a second C channel extrusion material 206 may be oriented perpendicularly to the first C channel 202. This second C channel 206 may be connected to the first C channel 202 by the corner bracket 204, forming a right angle.

The second C channel 206 may be fabricated from similar materials as the first C channel 202, ensuring compatibility and structural integrity. This configuration may allow for the creation of a rectangular or square frame, adaptable to various aperture sizes.

In several aspects, the system may include a third C channel 208, which is parallel to the second C channel 206. The third C channel 208 may be part of the overall frame structure, contributing to the enclosure's rigidity. This component may be constructed from materials such as aluminum or high-strength plastic, providing a balance of strength and weight. The parallel orientation of the third C channel 208 to the second C channel 206 may facilitate the formation of a complete frame assembly.

In other aspects, the system may include an inner extrusion channel 210, which is designed to fit inside the C channels 202, 206, and 208 when fully assembled. The inner extrusion channel 210 may provide additional support and may be constructed from materials such as polycarbonate or ABS plastic, offering flexibility and resilience. This component may be designed to slide within the C channels, allowing for adjustable positioning and secure attachment.

In many aspects, the method of manufacturing the frame assembly may involve an extrusion process, which may be economical for both metal and plastic materials. This process may include extruding the C channels 202, 206, and 208 from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In certain aspects, the system may be configured for tool-free assembly and disassembly, facilitating ease of installation and relocation. This feature may be particularly beneficial for users who require a temporary or portable safety solution. The system may also include a weather-resistant sealant applied to the frame assemblies to prevent moisture ingress, ensuring the system's durability in outdoor environments.

In some aspects, the system may be expandable by adding additional frame assemblies and corner brackets 204, allowing for customizable enclosure dimensions and/or shapes. This flexibility may enable users to tailor the system to their specific needs, whether for residential, commercial, or industrial applications. The system's adaptability and ease of use may provide a competitive advantage over existing safety solutions, addressing major real-world problems related to aperture and opening security.

In various embodiments, the components illustrated in FIG. 2 may be manufactured using standardized dimensions to facilitate mass production and reduce costs. By adhering to common sizing, the system can benefit from economies of scale, lowering the unit price. Furthermore, the use of recyclable packaging materials and compact disassembly of the components may contribute to environmentally friendly shipping practices.

To address weight and size reductions in packaging, the interlocking C channels 202, 206, and 208 may be designed with hollow or honeycomb structures. This design reduces material usage without compromising structural integrity, resulting in lighter components that are less expensive to ship. The packaging may also be modular, allowing multiple units to be securely packed together, optimizing space in shipping containers.

In certain aspects, the assembled frame structure system 300 may be engineered for flat-pack shipping. The components can be disassembled into flat elements that stack efficiently, drastically reducing the overall package size. This approach can lead to significant cost savings in storage and transportation, allowing for more competitive pricing in the market.

For applications requiring luxurious finishes, the frame components like c-channel 306 and c-channel 308 may be offered in materials like polished stainless steel or exotic hardwood veneers applied over composite substrates. These options provide a premium look and feel, appealing to customers who prioritize aesthetics alongside functionality.

In conclusion, the system for aperture and opening security as depicted in FIG. 2 may offer a versatile and effective solution for ensuring safety in various environments. The system's modular design, durable materials, and user-friendly features may make it an attractive option for a wide range of applications, providing peace of mind for users and enhancing safety in built environments.

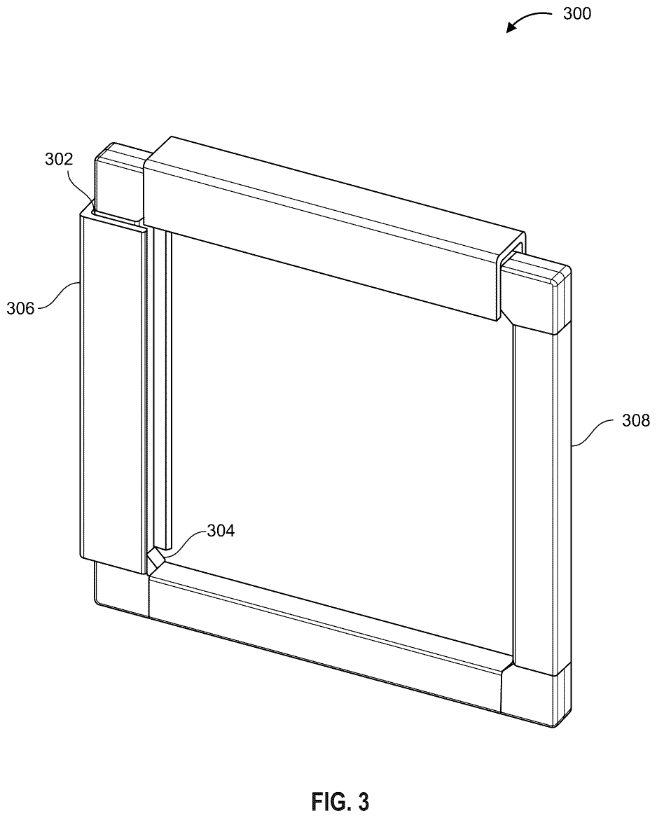

Referring to FIG. 3, the assembled view of the system 300 is depicted, illustrating the integration of various components to form a secure enclosure. In certain aspects, the system may include a mating edge 302 between the corner bracket and a square extrusion channel. This mating edge 302 may be configured to provide a seamless connection, enhancing the structural integrity of the assembly. The square extrusion channel may be fabricated from materials such as aluminum or high-strength plastic, offering rigidity and durability. The mating edge 302 may facilitate the alignment and secure attachment of the corner bracket to the square extrusion channel and/or other adjacent frame assemblies. Various channels may interlock in the assembly to form a continuous barrier around a screen.

In some aspects, the system may further include an inside surface 304 of the corner bracket, which remains visible when fully assembled. This inside surface 304 may be designed to provide additional support and stability to the overall structure. The corner bracket may be constructed from durable materials such as reinforced plastic or metal alloys, ensuring long-term performance and resistance to environmental factors. The visible inside surface 304 may also serve an aesthetic function, contributing to the overall appearance of the assembled system.

In various aspects, the system may include a C channel extrusion material 306 surrounding the square extrusion channel. The C channel 306 may be configured to provide additional structural support and may be fabricated from materials such as steel or polycarbonate. This component may enhance the rigidity of the assembly, ensuring that the system can withstand applied forces without deformation. The C channel 306 may also serve as a guide for the square extrusion channel, facilitating precise alignment during assembly.

In several aspects, the system may include another square extrusion channel 308, which is parallel to the one that the C channel 306 surrounds but opposite it in the rectangular-prism-shaped assembly structure. This square extrusion channel 308 may be part of the overall frame structure, contributing to the enclosure's rigidity and stability. The parallel orientation of the square extrusion channel 308 to the C channel 306 may facilitate the formation of a complete frame assembly, adaptable to various aperture sizes.

In other aspects, the system may be configured for tool-free assembly and disassembly, facilitating ease of installation and relocation. This feature may be particularly beneficial for users who require a temporary or portable safety solution. The system may also include a weather-resistant sealant applied to the frame assemblies to prevent moisture ingress, ensuring the system's durability in outdoor environments.

In many aspects, the system may be expandable by adding additional frame assemblies and corner brackets, allowing for customizable enclosure dimensions and/or shapes. This flexibility may enable users to tailor the system to their specific needs, whether for residential, commercial, or industrial applications. The system's adaptability and ease of use may provide a competitive advantage over existing safety solutions, addressing major real-world problems related to aperture and opening security.

In conclusion, the system for life safety in built environment thresholds as depicted in FIG. 3 may offer a versatile and effective solution for ensuring safety in various environments. The system's modular design, durable materials, and user-friendly features may make it an attractive option for a wide range of applications, providing peace of mind for users and enhancing safety in built environments.

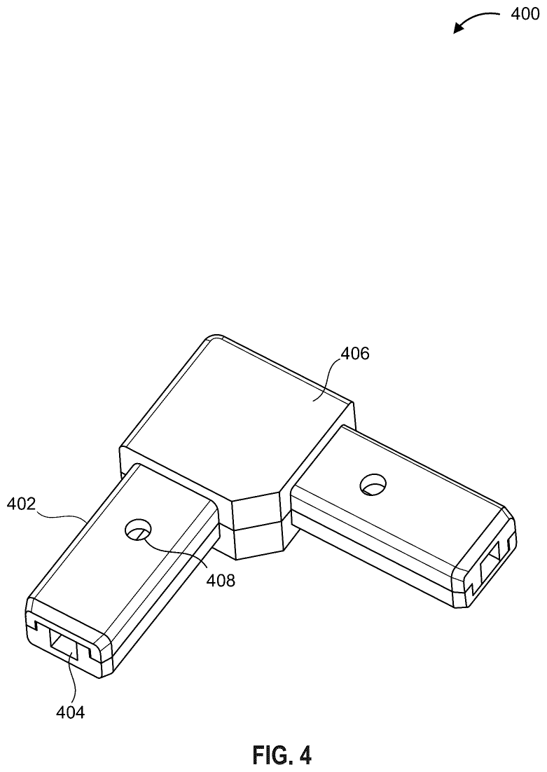

Referring to FIG. 4, the corner bracket subsystem 400 is depicted, illustrating its role in the assembly of the system for life safety in built environment thresholds. In certain aspects, the subsystem may include a chamfered edge 402 of an arm connector part. This chamfered edge 402 may facilitate the smooth insertion and alignment of the arm connector with other components, reducing friction and wear during assembly. The arm connector may be constructed from materials such as aluminum or reinforced plastic, providing a balance of strength and lightweight properties.

In some aspects, the subsystem may feature a hollow inside opening 404 between the pieces that make up the corner bracket subsystem 400. This hollow opening 404 may serve to reduce material usage and weight while maintaining structural integrity. The opening may also allow for the passage of fasteners or other securing elements, enhancing the versatility of the subsystem in various assembly configurations.

In various aspects, the subsystem may include a larger dimensioned body part 406 that connects two or more protruding arm pieces. This body part 406 may be visible even after assembly and may be designed to be flush with the outer C channel, providing a seamless appearance. The body part 406 may be fabricated from durable materials such as metal alloys or high-strength polymers, ensuring long-term performance and resistance to environmental factors.

In several aspects, the subsystem may include an inside surface 408 of an aperture, which may receive a fastener of various sorts to secure the subsystem to other components during the assembly process. This aperture's surface 408 may be designed to accommodate screws, bolts, clips, a series or combination of these, or other fastening means, providing flexibility in the choice of securing elements. The inside surface 408 may be treated to enhance grip and prevent slippage, ensuring a secure connection.

In other aspects, the method of assembly may involve several steps, beginning with the alignment of the chamfered edge 402 with corresponding components. Step 450 may include inserting the arm connector into the mating component, ensuring proper alignment and fit. Step 455 may involve securing the connection using fasteners inserted through the aperture surface 408, providing stability to the assembly.

In many aspects, step 460 may include positioning the larger dimensioned body part 406 to be flush with the outer C channel, ensuring a seamless appearance. Step 465 may involve checking the alignment and fit of all components, making adjustments as necessary to ensure structural integrity. Step 470 may include applying a weather-resistant sealant to the assembled components, protecting against moisture ingress and environmental degradation.

In certain aspects, step 475 may involve testing the assembled system for stability and performance, ensuring that all connections are secure and that the system functions as intended. This comprehensive assembly process may ensure that the system is robust, reliable, and suitable for use in various built environment thresholds.

In various embodiments, the corner bracket subsystem 400 may be produced using additive manufacturing techniques such as 3D printing. This method allows for on-demand production, reducing inventory costs and enabling rapid customization for specific project requirements. Materials like reinforced nylon or metal powders can be selected based on cost and performance considerations.

To further enhance shipping efficiency, the corner brackets may be designed to interlock with each other during packing, forming a compact unit that minimizes wasted space. Including clear assembly instructions with visual guides can reduce installation time and potential errors, adding value for both professional installers and end-users.

In conclusion, the corner bracket subsystem 400 as depicted in FIG. 4 may offer a versatile and effective solution for connecting and securing components in the system for life safety in built environments. The subsystem's design, materials, and assembly methods may provide a competitive advantage, addressing major real-world problems related to safety and security in built environments.

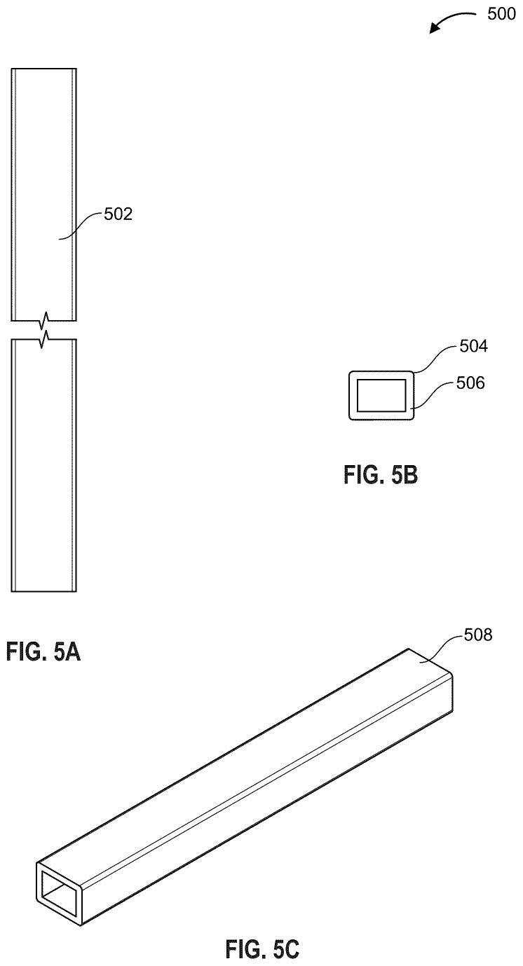

Referring to FIG. 5A, the side view of a square channel 502 is depicted, illustrating its role in forming a first frame assembly. This square channel 502 may be configured to provide structural support and may be fabricated through an extrusion process. The material selection for the square channel 502 may include metals such as aluminum, steel, or stainless steel, offering rigidity and durability. Alternatively, plastics such as polyvinyl chloride (PVC), polyethylene (PE), or polycarbonate (PC) may be used, providing a lightweight and cost-effective option.

Turning to FIG. 5B, the front view of the square channel 504 is shown, highlighting its slightly filleted or chamfered corners. These design features may enhance the aesthetic appeal and reduce sharp edges, facilitating safer handling during assembly. The material body 506 of the extrusion may be constructed from a variety of materials, including brass, bronze, or nickel alloys for metal options, and acrylonitrile butadiene styrene (ABS) or nylon for plastic options. These materials may be selected based on their properties, such as corrosion resistance, impact strength, and ease of manufacturing. The mesh, once constructed, preferably has a tensile strength sufficient to withstand impact forces, which may come from children or other forces.

In FIG. 5C, a perspective view of an example channel 508 for a connector subsystem is illustrated. This channel 508 may be part of a larger assembly, designed to interlock with other components such as a U channel or corner unit. The channel 508 may be manufactured using efficient logistics planning, optimizing the extrusion process to minimize material waste and reduce production costs. The channel's design may allow for adjustable positioning, accommodating varying window dimensions and ensuring a secure fit within the frame assembly.

In one embodiment of the invention, the square channel 502 may further include features that facilitate the integration of a screen constructed from a durable material resistant to tearing. This screen may be attached using fastening means, such as screws, configured to penetrate the U channel and square channel, securing the screen in place. The fastening means may be designed to maintain the integrity of the system under applied pressure, preventing unauthorized removal or accidental dislodgement.

In some aspects, the system may be configured for installation from the interior of a building, eliminating the need for external access. This feature may facilitate ease of installation and maintenance, allowing users to install the system without professional assistance. The system may also include a locking mechanism configured to prevent unauthorized removal of the screen from the window frame, enhancing security and safety.

In various aspects, the method of manufacturing the frame assembly may involve an extrusion process, which may be economical for both metal and plastic materials. This process may include extruding the square and U channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In certain aspects, the square channel 502 may be manufactured using high-strength aluminum alloys, which provide an optimal balance between durability and weight reduction. The lighter weight contributes to lower shipping costs and easier handling during installation. The channels may also be offered in standard lengths that fit within common carrier size restrictions, avoiding additional freight charges.

For customers desiring high-end materials, the square channel may be available in carbon fiber composites. This material offers exceptional strength-to-weight ratios and a sleek, modern appearance, appealing to luxury residential or commercial projects. The use of premium materials can be highlighted in marketing materials to differentiate the product in the marketplace.

In conclusion, the example channel for a connector subsystem as depicted in FIGS. 5A-5B may offer a versatile and effective solution for ensuring safety in built environments. The system's modular design, durable materials, and user-friendly features may make it an attractive option for a wide range of applications, providing peace of mind for users and enhancing safety in built environments.

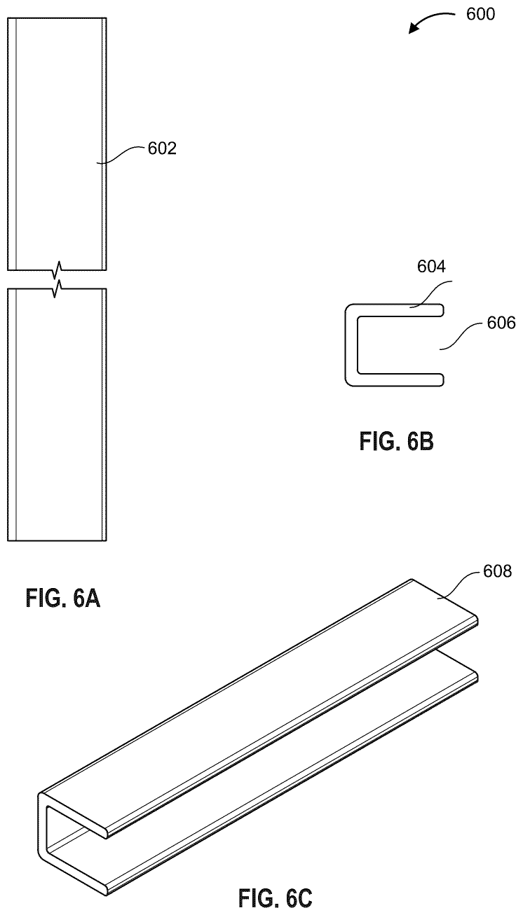

Referring to FIG. 6A, the side view of a C channel 602 is depicted, illustrating its role in engaging with a square channel to form a secure connection within the frame assembly. This C channel 602 may be configured to provide structural support and may be fabricated through an extrusion process. The material selection for the C channel 602 may include metals such as aluminum, steel, or stainless steel, offering rigidity and durability. Alternatively, plastics such as polyvinyl chloride (PVC), polyethylene (PE), or polycarbonate (PC) may be used, providing a lightweight and cost-effective option.

Turning to FIG. 6B, the front view of the C channel 604 is shown, highlighting its slightly filleted or chamfered corners. These design features may enhance the aesthetic appeal and reduce sharp edges, facilitating safer handling during assembly. The dimensions of the C channel 604 may be adjusted to provide a snug or loose fit around the square channel, depending on the specific application requirements. The edges of the C channel 604 may be flat or angled at 45 degrees to fully cover the corners, providing additional protection and stability. Screw holes may be included or omitted based on the fastening needs of the assembly.

The material body c channels 606 of the extrusion may be constructed from a variety of materials, including brass, bronze, or nickel alloys for metal options, and acrylonitrile butadiene styrene (ABS) or nylon for plastic options. These materials may be selected based on their properties, such as corrosion resistance, impact strength, and ease of manufacturing. The choice of material may also be influenced by the intended use environment, ensuring that the C channel 604 performs optimally under various conditions.

In FIG. 6C, a perspective view of an example C channel 608 for a connector subsystem is illustrated. This C channel 608 may be part of a larger assembly, designed to interlock with other components such as a square channel or corner unit.

The C channel 608 may be manufactured using efficient logistics planning, optimizing the extrusion process to minimize material waste and reduce production costs. The channel's design may allow for adjustable positioning, accommodating varying window dimensions and ensuring a secure fit within the frame assembly.

In one embodiment of the invention, the C channel 602 may further include features that facilitate the integration of a screen constructed from a durable material resistant to tearing. This screen may be attached using fastening means, such as screws, configured to penetrate the C channel and square channel, securing the screen in place. The fastening means may be designed to maintain the integrity of the system under applied pressure, preventing unauthorized removal or accidental dislodgement.

In some aspects, the system may be configured for installation from the interior of a building, eliminating the need for external access. This feature may facilitate ease of installation and maintenance, allowing users to install the system without professional assistance. The system may also include a locking mechanism configured to prevent unauthorized removal of the screen from the window frame, enhancing security and safety.

In various aspects, the method of manufacturing the frame assembly may involve an extrusion process, which may be economical for both metal and plastic materials. This process may include extruding the square and C channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In various embodiments, the C channel 602 may be designed with adjustable features that accommodate slight variations in window dimensions, reducing the need for custom-sized parts and streamlining inventory management. By standardizing on a few adjustable models, production complexity is reduced, leading to cost savings that can be passed on to the consumer.

To minimize packaging size, the C channels 604 and c channel material body 606 may be nested within each other or within the square channels during shipping. Protective coatings or sleeves can prevent scratching or damage, ensuring that the components arrive in pristine condition. This efficient packaging method reduces both volume and weight, lowering shipping costs.

In conclusion, the example C channel for a connector subsystem as depicted in FIGS. 6A-6C may offer a versatile and effective solution for ensuring safety in built environments. The system's modular design, durable materials, and user-friendly features may make it an attractive option for a wide range of applications, providing peace of mind for users and enhancing safety in built environments.

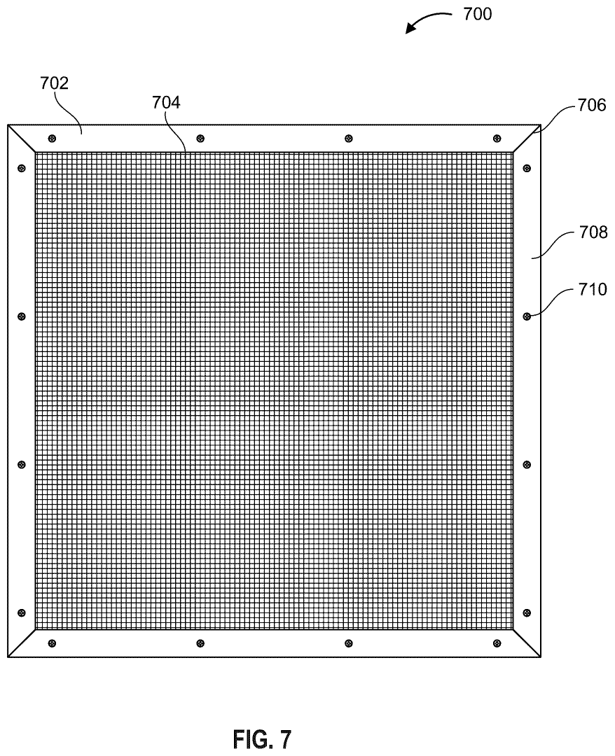

Referring to FIG. 7, the fully assembled life safety system 700 is depicted, illustrating the integration of various components to form a secure enclosure. In certain aspects, the system may include a C channel 702 which forms the complete frame around the screen. This C channel 702 may be configured to provide structural support and may be fabricated through an extrusion process. The material selection for the C channel 702 may include metals such as aluminum, steel, or stainless steel, offering rigidity and durability. Alternatively, plastics such as polyvinyl chloride (PVC), polyethylene (PE), or polycarbonate (PC) may be used, providing a lightweight and cost-effective option.

The material body of the screen 704 may be constructed from a durable material resistant to tearing. This screen 704 may be made from metal mesh or molded plastic, ensuring flexibility and resilience while maintaining structural integrity. The choice of material may be influenced by the intended use environment, ensuring that the screen 704 performs optimally under various conditions. The screen may also include a protective coating to enhance durability and weather resistance, providing long-term performance in outdoor environments.

The angle at which the edges meet or join together 706 may be designed to ensure a seamless connection, enhancing the structural integrity of the assembly. The edges may be flat or angled at 45 degrees to fully cover the corners, providing additional protection and stability. This design feature may also contribute to the aesthetic appeal of the system, ensuring a clean and professional appearance.

A front view of the C channel 708 is shown, highlighting its slightly filleted or chamfered corners. These design features may enhance the aesthetic appeal and reduce sharp edges, facilitating safer handling during assembly. The dimensions of the C channel 708 may be adjusted to provide a snug or loose fit around the square channel, depending on the specific application requirements. Screw holes may be included or omitted based on the fastening needs of the assembly.

The fastener 710 may be configured to connect through the C channel 702, the mesh underneath it, and the square channel, securing all components as an assembly. This fastener 710 may be designed to maintain the integrity of the system under applied pressure, preventing unauthorized removal or accidental dislodgement.

The fastening means may include screws, bolts, or other mechanical fasteners, providing flexibility in the choice of securing elements.

In one embodiment of the invention, the system may be configured for installation from the interior of a building, eliminating the need for external access. This feature may facilitate ease of installation and maintenance, allowing users to install the system without professional assistance. The system may also include a locking mechanism configured to prevent unauthorized removal of the screen from the window frame, enhancing security and safety.

In various aspects, the method of manufacturing the frame assembly may involve an extrusion process, which may be economical for both metal and plastic materials. This process may include extruding the square and C channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In certain aspects, the material of screen 704 may be manufactured from advanced polymers like polyether ether ketone (PEEK) for applications requiring high strength and chemical resistance. While more expensive, these materials offer superior performance in extreme environments, justifying the cost for specialized industrial or luxury applications.

The system may be shipped in a partially assembled state to reduce on-site labor costs. Critical joints or components can be pre-assembled at the factory, leveraging controlled manufacturing conditions to ensure quality. This approach can reduce the time and expertise required for installation, making the product more accessible to a broader market.

In conclusion, the fully assembled life safety system 700 as depicted in FIG. 7 may offer a versatile and effective solution for ensuring safety in built environments. The system's modular design, durable materials, and user-friendly features may make it an attractive option for a wide range of applications, providing peace of mind for users and enhancing safety in built environments.

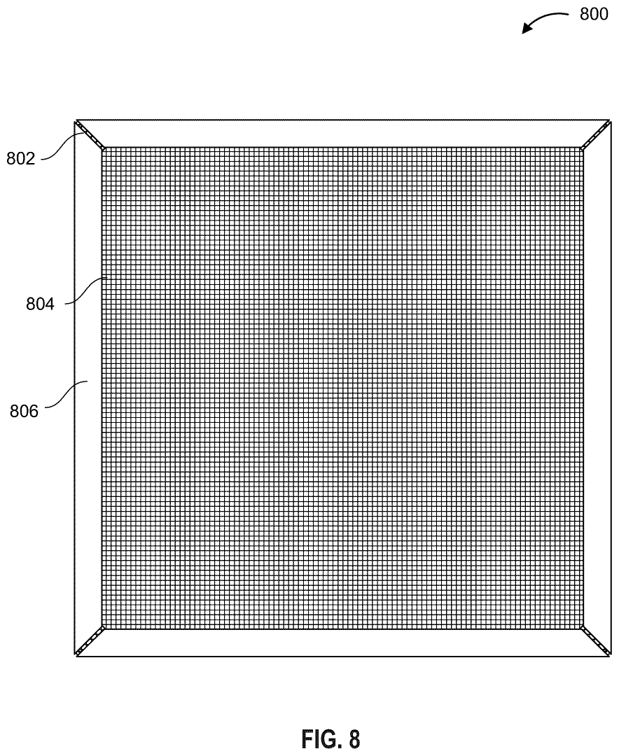

Referring to FIG. 8, the fully assembled life safety system 800 is depicted, illustrating a configuration where the fasteners are not visible, and the corners are slightly different. In certain aspects, the system may include a C channel joint 802 which forms the complete frame around the screen. This C channel joint 802 may be configured to provide structural support and may include various mating embodiments such as a gap, foam, grommet, or adhesive to ensure a secure connection. The C channel joint 802 may be fabricated from materials such as aluminum, steel, or stainless steel, offering rigidity and durability. Alternatively, plastics such as polyvinyl chloride (PVC), polyethylene (PE), or polycarbonate (PC) may be used, providing a lightweight and cost-effective option.

The material body of the screen 804 may be constructed from a durable material resistant to tearing. This screen 804 may be made from metal mesh or molded plastic, ensuring flexibility and resilience while maintaining structural integrity. The choice of material may be influenced by the intended use environment, ensuring that the screen 804 performs optimally under various conditions. The screen may also include a protective coating to enhance durability and weather resistance, providing long-term performance in outdoor environments.

The C channel 806 itself is the only visible part of the frame in this embodiment, with corner brackets not visible unless just barely under the mesh in the open corner crack. The C channel 806 may be designed to provide a seamless appearance, enhancing the aesthetic appeal of the system. The dimensions of the C channel 806 may be adjusted to provide a snug or loose fit around the square channel, depending on the specific application requirements. The edges may be flat or angled at 45 degrees to fully cover the corners, providing additional protection and stability.

In one embodiment of the invention, the system may be configured for installation from the interior of a building, eliminating the need for external access. This feature may facilitate ease of installation and maintenance, allowing users to install the system without professional assistance. The system may also include a locking mechanism configured to prevent unauthorized removal of the screen from the window frame, enhancing security and safety.

In various aspects, the method of manufacturing the frame assembly may involve an extrusion process, which may be economical for both metal and plastic materials. This process may include extruding the square and C channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In various embodiments, the seamless appearance of the system can be achieved through precision manufacturing techniques such as CNC machining, which allows for tight tolerances and high-quality finishes without the need for additional surface treatments. While this may increase manufacturing costs, it offers a premium product that appeals to customers willing to invest in superior craftsmanship.

To address cost-effective shipping, the system may be designed for modular assembly, where large sections can be detached and packed flat. Innovative packaging solutions, such as vacuum-sealed wrapping or form-fitting foam inserts, can protect delicate finishes and components during transit while maximizing packing density.

In conclusion, the fully assembled life safety system 800 as depicted in FIG. 8 may offer a versatile and effective solution for ensuring safety in built environments. The system's modular design, durable materials, and user-friendly features may make it an attractive option for a wide range of applications, providing peace of mind for users and enhancing safety in built environments.

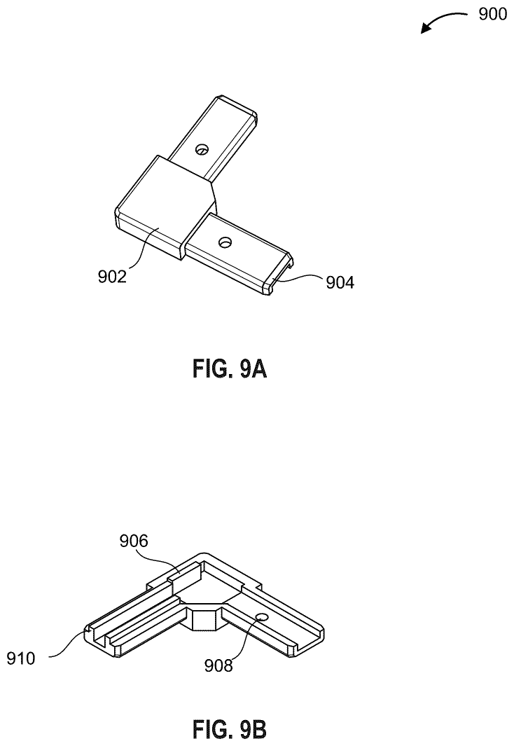

Referring to FIG. 9A, the corner bracket assembly 900 is depicted, illustrating the integration of components to form a secure connection within the frame assembly. The main corner block 902 part connects arms, providing structural support and alignment. The arms are designed to smoothly insert into the square bracket, with chamfered ends 904 facilitating easy insertion and reducing friction during assembly.

The corner block 902 may be constructed from materials such as aluminum, steel, or reinforced plastic, offering a balance of strength and lightweight properties.

The material body of the screen, which may be metal or plastic, could include options such as polyvinyl chloride (PVC), polyethylene (PE), or polycarbonate (PC) for plastic, and aluminum or stainless steel for metal. These materials are selected based on their durability, resistance to environmental factors, and ease of manufacturing. The choice of material may also be influenced by the intended use environment, ensuring optimal performance.

Turning to FIG. 9B, the block 906 for locking and positioning is shown, designed to secure the assembly upon integration with the subsystem in FIG. 9A. This block 906 may include features such as alignment rails 910, which assist in fitting and may be configured for snap fit, snug fit, or adhesive bonding. The alignment rails 910 ensure precise positioning and stability within the frame assembly.

The hole 908 for fasteners or alignment pegs is optional and may be included to enhance the connection between components. This feature allows for the use of screws, bolts, or other mechanical fasteners, providing flexibility in the choice of securing elements. The hole 908 may also serve as a guide for alignment pegs, ensuring accurate assembly and reducing the risk of misalignment.

In one embodiment of the invention, the corner bracket assembly 900 may be configured to enhance the structural integrity of the first frame assembly. The assembly may include a locking mechanism to prevent unauthorized removal of the screen from the window frame, enhancing security and safety. The system may be designed for installation from the interior of a building, eliminating the need for external access and facilitating ease of installation and maintenance.

In various aspects, the method of manufacturing the frame assembly may involve an extrusion process, which may be economical for both metal and plastic materials. This process may include extruding the square and U channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In certain aspects, the corner bracket assembly 900 may utilize biodegradable or recycled materials for sustainability-conscious consumers and projects. For example, components made from recycled aluminum or bioplastics can reduce the environmental impact, appealing to green building initiatives and certifications like LEED.

The design may also incorporate multifunctional elements, such as integrated attachment points for accessories like planters, signage, or lighting fixtures. This versatility adds value to the product by expanding its utility beyond safety applications, potentially opening additional market segments.

In conclusion, the corner bracket assembly 900 as depicted in FIG. 9 may offer a versatile and effective solution for ensuring safety in built environments. The system's modular design, durable materials, and user-friendly features may make it an attractive option for a wide range of applications, providing peace of mind for users and enhancing safety in built environments.

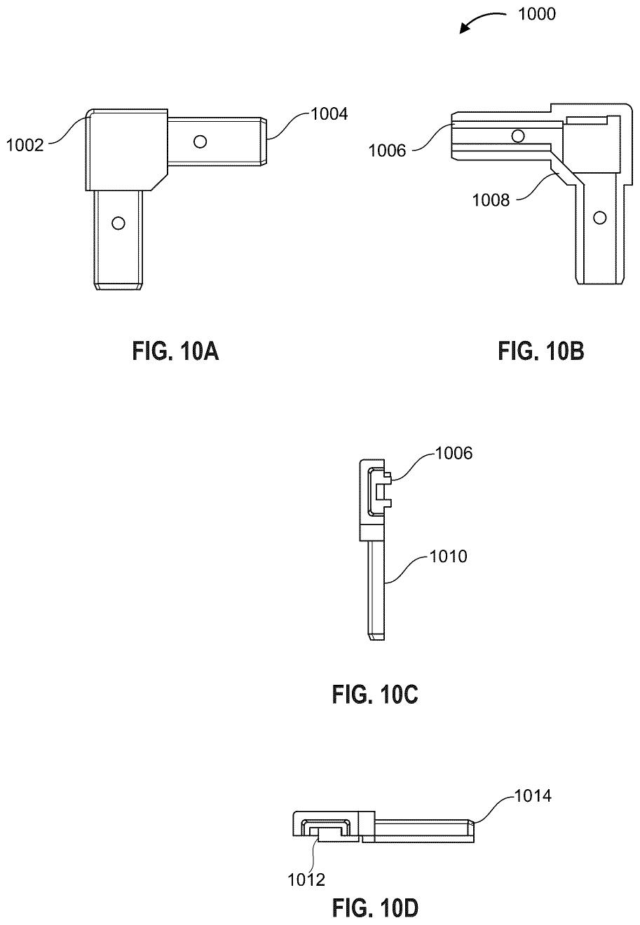

Referring to FIG. 10A, the corner bracket subsystem 1000 is depicted, illustrating the integration of components to form a secure connection within the frame assembly. The main block of the first piece features a rounded corner 1002, designed to enhance ergonomics and safety by reducing sharp edges. This rounded corner 1002 may also contribute to the aesthetic appeal of the assembly. The end of the first arm 1004 is chamfered to facilitate smooth insertion into another frame subsystem, such as a square or rectangular extrusion. This design ensures easy alignment and reduces friction during assembly.

The material body of the screen, which may be metal or plastic, could include options such as polyvinyl chloride (PVC), polyethylene (PE), or polycarbonate (PC) for plastic, and aluminum or stainless steel for metal. These materials are selected based on their durability, resistance to environmental factors, and ease of manufacturing. The choice of material may also be influenced by the intended use environment, ensuring optimal performance.

Turning to FIG. 10B, a channel of extruded material 1006 is shown as part of the singular block, which is a second piece of the corner subsystem assembly.

This channel 1006 may assist with fitting, mating, and positioning upon assembly with the subsystem in FIG. 10A. The inner corner protrusion 1008 is designed for ergonomics, safety, and aesthetics, providing additional support and stability. This feature is optional and may be included based on specific design requirements.

In FIG. 10C, the edge 1010 of one of the blocks is depicted, which helps lock it in place. This edge 1010 may be designed to engage with corresponding components, ensuring a secure and stable connection. The alignment rail subsystem 1012 assists with fitting and may be configured for snap fit, snug fit, or adhesive bonding. This subsystem ensures precise positioning and stability within the frame assembly.

FIG. 10D illustrates the corner of the chamfered edge 1014 of the subsystem piece. This chamfered edge 1014 may enhance the ease of assembly by guiding the insertion of the arm into the frame, reducing the risk of misalignment. The design of the chamfered edge 1014 may also contribute to the overall aesthetic appeal of the assembly, providing a clean and professional appearance.

In one embodiment of the invention, the corner bracket subsystem 1000 may be configured to enhance the structural integrity of the first frame assembly. The assembly may include a locking mechanism to prevent unauthorized removal of the screen from the window frame, enhancing security and safety. The system may be designed for installation from the interior of a building, eliminating the need for external access and facilitating ease of installation and maintenance.

In various aspects, the method of manufacturing the frame assembly may involve an extrusion process, which may be economical for both metal and plastic materials. This process may include extruding the square and U channels from a selected material, optimizing the extrusion process to minimize material waste and reduce production costs. The extruded components may be cut to predetermined lengths suitable for assembly into the frame structure, and a surface treatment may be applied to enhance durability and resistance to environmental factors.

In various embodiments, the corner bracket subsystem 1000 may be offered in customizable colors or finishes, allowing architects and designers to match or contrast with existing building aesthetics. Options like powder-coated colors, metallic finishes, or even custom graphics can be applied without significantly increasing production costs.

For enhanced cost-effectiveness, the components may be designed for universal application across multiple product lines, reducing the number of unique parts that need to be manufactured and stocked. This commonality simplifies supply chain management and can lead to bulk purchasing discounts on raw materials.

Moreover, to reduce packaging weight and volume, lightweight packaging materials such as corrugated cardboard with honeycomb structures or inflatable air cushions may be used. These materials provide adequate protection while keeping shipping costs low and are often recyclable, aligning with environmental sustainability efforts.

In conclusion, the corner bracket subsystem 1000 as depicted in FIG. 10 may offer a versatile and effective solution for ensuring safety in built environments.

The system's modular design, durable materials, and user-friendly features may make it an attractive option for a wide range of applications, providing peace of mind for users and enhancing safety in built environments.

### CONCLUSION

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

While the above description details certain embodiments of the invention and describes the best mode contemplated, no matter how detailed the above appears in text, the invention can be practiced in many ways. Therefore, implementation details may vary considerably while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated.

What is claimed is:

1. A child safety screen system configured for installation within a window frame, comprising:
a square channel forming a first frame assembly, the square channel being configured to provide structural support;
a U channel configured to engage with the square channel, the U channel being adjustable to accommodate varying window dimensions;
a corner unit configured to connect with the square channel, forming a rigid enclosure;
a screen disposed over the first frame assembly, the screen being constructed from a durable material resistant to tearing; and
fastening means for securing the U channel to the square channel, thereby integrating the screen into the window frame,
wherein the child safety screen system is configured to prevent accidental falls from the window.

2. The child safety screen system of claim 1, further comprising a plurality of corner units, each configured to enhance the structural integrity of the first frame assembly.

3. The child safety screen system of claim 1, wherein screen is constructed from a plastic or a metal alloy.

4. The child safety screen system of claim 3, further comprising a protective coating on the screen to enhance durability and weather resistance.

5. The child safety screen system of claim 1, wherein the U channel is configured to slide over the square channel, allowing for adjustable positioning of the screen.

6. The child safety screen system of claim 1, wherein the fastening means comprises screws configured to penetrate the U channel and square channel, securing the screen in place.

7. The child safety screen system of claim 1, wherein the system is configured for installation from an interior of a building, eliminating a need for external access.

8. The child safety screen system of claim 1, further comprising a locking mechanism configured to prevent unauthorized removal of the screen from the window frame.

9. The child safety screen system of claim 1, wherein a method of manufacturing the frame assembly involves an extrusion process, the process being economical for both metal and plastic materials, comprising:
extruding the square and U channels from a selected material, wherein the extrusion process is optimized to minimize material waste and reduce production costs;
cutting extruded components to predetermined lengths suitable for assembly into the frame structure; and
applying a surface treatment to the extruded components to enhance durability and resistance to environmental factors.

10. The child safety screen system of claim 1, wherein a method of manufacturing the screen material comprises:
weaving metal wires into a mesh configuration for the metal screen, ensuring uniformity and strength across a screen surface; or
molding plastic into a mesh configuration for the plastic screen, utilizing a process that ensures flexibility and resilience while maintaining structural integrity.

11. The method of manufacturing a child safety screen as recited in claim 10, wherein the metal screen is attached to the frame by a crimping process, or the plastic screen is attached by a thermal bonding process, each method selected to optimize durability and cost-effectiveness for the respective material.

12. The child safety screen system of claim 1, wherein the frame assembly and screen material are constructed from a variety of materials, including:
Metals: aluminum, steel, stainless steel, titanium, copper, brass, bronze, or nickel alloys; and
Plastics: polyvinyl chloride (PVC), polyethylene (PE), polypropylene (PP), polycarbonate (PC), acrylonitrile butadiene styrene (ABS), polystyrene (PS), or nylon.

13. A modular safety screen system for use in various protective applications, comprising:
a plurality of frame assemblies, each frame assembly comprising a square channel and a U channel, the channels being configured to interlock and form a continuous barrier;
a plurality of corner units configured to connect adjacent frame assemblies, thereby forming a modular enclosure;
one or more screens, each screen being inserted between each frame assembly and constructed from a high-strength material; and
fastening means for securing each screen to its respective frame assembly, wherein the modular safety screen system is adaptable to serve as a window-mounted child safety screen, a deck barrier, or an animal enclosure.

14. The modular safety screen system of claim 13, wherein each screen is constructed from a mesh material with a tensile strength sufficient to withstand impact forces.

15. The modular safety screen system of claim 13, further comprising a plurality of extension units configured to increase a height of the modular enclosure for use as a deck barrier.

16. The modular safety screen system of claim 13, wherein the fastening means comprises a series of clips configured to engage with the U channel and secure the screen.

17. The modular safety screen system of claim 13, further comprising a hinge mechanism configured to allow selective opening of a portion of the modular enclosure.

18. The modular safety screen system of claim 13, wherein the system is configured for tool-free assembly and disassembly, facilitating ease of installation and relocation.

19. The modular safety screen system of claim 13, further comprising a weather-resistant sealant applied to the frame assemblies to prevent moisture ingress.

20. The modular safety screen system of claim 13, wherein the system is configured to be expandable by adding additional frame assemblies and corner units, allowing for customizable enclosure dimensions and/or shapes.
